(19) United States
(12) Patent Application Publication
(10) Pub. No.: US 2012/0241220 A1
(43) Pub. Date: Sep. 27, 2012

(54) Dendritic Surfactants and Extended Surfactants for Drilling Fluid Formulations

(75) Inventors: Lirio Quintero, Houston, TX (US); David E. Clark, Humble, TX (US); Antonio Enrique Cardenas, Houston, TX (US); Jean-Louis Salager, Merida (VE); Ana Forgiarini, Merida (VE); Ali Hasan Bahsas, Merida (VE)

(73) Assignee: BAKER HUGHES INCORPORATED, Houston, TX (US)

(21) Appl. No.: 13/474,468

(22) Filed: May 17, 2012

Related U.S. Application Data
(63) Continuation-in-part of application No. 12/414,888, filed on Mar. 31, 2009, now Pat. No. 8,235,120.
Application No. 12/414,888 is a continuation-in-part of application No. 12/146,647, filed on Jun. 26, 2008, now Pat. No. 8,091,646.
Application No. 12/414,888 is a continuation-in-part of application No. 11/866,486, filed on Oct. 3, 2007, now Pat. No. 8,091,645.
(60) Provisional application No. 60/947,870, filed on Jul. 3, 2007.

(51) Int. Cl. C09K 8/34; E21B 7/00

(52) U.S. Cl. 175/65; 507/136; 507/133

(57) ABSTRACT

Modified surfactants may be added to an oil-based drilling fluid where the modified surfactant is selected from the group consisting of an extended surfactant, a dendritic surfactant, a dendritic extended surfactant, and combinations thereof. These oil-based drilling fluids may be used for drilling a well through a subterranean reservoir, while circulating the oil-based drilling fluid through the wellbore. The oil-based drilling fluid may include at least modified surfactant, at least one non-polar continuous phase, and at least one polar non-continuous phase. The modified surfactant may have propoxylated/ethoxylated spacer arms extensions. The modified surfactant may have intramolecular mixtures containing hydrophilic and lipophilic portions. They attain high solubilization in the oil-based drilling fluid and may be, in some instances, insensitive to temperature making them useful for a wide variety of oil types.

### CROSS-REFERENCE TO RELATED APPLICATIONS

This application is a continuation-in-part application from U.S. patent application Ser. No. 12/414,888 filed Mar. 31, 2009, which is also a continuation-in-part application from U.S. patent application Ser. No. 12/146,647 filed Jun. 26, 2008, now U.S. Pat. No. 8,091,646, which in turn claims the benefit of U.S. Provisional Application No. 60/947,870 filed Jul. 3, 2007, and is also a continuation-in-part application of U.S. Ser. No. 11/866,486 filed Oct. 3, 2007, now U.S. Pat. No. 8,091,645, all of which are incorporated herein in their entirety.

### TECHNICAL FIELD

The present invention relates to methods and compositions for drilling a well through a subterranean reservoir while circulating an oil-based drilling fluid through the wellbore, which may have at least one modified surfactant selected from the group consisting of extended surfactant, a dendritic surfactant, a dendritic extended surfactant, or combinations thereof; at least one non-polar continuous phase; and at least one polar non-continuous phase.

### BACKGROUND

Drilling fluids used in the drilling of subterranean oil and gas wells along with other drilling fluid applications and drilling procedures are known. In rotary drilling there are a variety of functions and characteristics that are expected of drilling fluids, also known as drilling muds, or simply “muds”. The drilling fluid is expected to carry cuttings up from beneath the bit, transport them up the annulus, and allow their separation at the surface, while at the same time the rotary bit is cooled and cleaned. A drilling mud is also intended to reduce friction between the drill string and the sides of the borehole, while maintaining the stability of uncased sections of the borehole. The drilling fluid is formulated to prevent unwanted influxes of formation fluids into penetrated permeable rocks, and also often to form a thin, low permeability filter cake that temporarily seals pores, other openings and formations penetrated by the bit. The drilling fluid may also be used to collect and interpret information available from drill cuttings, cores and electrical logs. It will be appreciated that within the scope of the claimed invention herein, the term “drilling fluid” also encompasses “drill-in fluids”.

Drilling fluids are typically classified according to their base fluid. In water-based muds, solid particles are suspended in water or brine. Oil can be emulsified in the water. Nonetheless, the water is the continuous phase. Oil-based muds are the opposite or inverse. Oil-based muds are water-in-oil emulsions called invert emulsions, where solid particles are suspended in oil, and water or brine is emulsified in the oil; therefore, the oil is the continuous phase. In oil-based mud, the oil may consist of any oil that may include, but is not limited to, diesel, mineral oil, esters, or alpha-olefins. OBMs as defined herein also include synthetic-based fluids or muds (SBMs) which are formulated with synthetic oils which are not necessarily limited to, olefin oligomers of ethylene esters made from vegetable fatty acids and alcohols, ethers and polyethers made from alcohols and polyalcohols.

Surfactants are important agents in the preparation and maintenance of an oil-based drilling fluid. Surfactants help to lower the interfacial tension between the polar non-continuous phase (e.g. water) and a non-polar continuous phase (e.g. oil). A surfactant may act as an emulsifier and allow a stable invert emulsion to form. A surfactant may also act as a wetting agent. Types of surfactants that may be used for oil-based drilling fluids may include, but are not limited to calcium fatty-acid soaps made from various fatty acids and lime, or derivatives such as amides, amines, amidoamines and imidazolines made by reactions of fatty acids and various ethanolamine compounds.

Surfactants may also be used for carrying additives within the oil-based drilling fluid and delivering those additives downhole. Often, the surfactant may surround polar fluid droplets of the polar non-continuous phase where the lipophilic components of the surfactants are solubilized mainly into the non-polar continuous phase (e.g. oil). Additionally, other additives dispersed within the continuous phase but having less polarity than the continuous phase may be encompassed by the solubilized surfactant to form a plurality of droplets. This allows the additives to be controllably released downhole by a triggering mechanism. Also, dispersant additives specific to drilling fluids may be added to the polar non-continuous phase where the additives and polar fluid are emulsified in droplets.

Still, a need exists for a modified surfactant to further enhance emulsion stabilization and oil wettability of solids, within an oil-based drilling fluid.

### SUMMARY

There is provided, in one non-limiting form, a method of drilling a well through a subterranean reservoir. The method may involve drilling the well, while circulating an oil-based drilling fluid through the wellbore. The oil-based drilling fluid may include components, such as but not limited to at least one modified surfactant selected from the group consisting of extended surfactants, dendritic surfactants, and/or dendritic extended surfactants; at least one non-polar continuous phase; and at least one polar non-continuous phase.

There is also provided, in another non-limiting form, an oil-based drilling fluid, which may include but is not limited to at least one modified surfactant, at least one non-polar continuous phase, at least one polar non-continuous phase, and at least one additive. The additive may be or include structural stabilizers, viscosifiers, chelating agents, filtration control additives, rheological modifiers, suspending agents, dispersants, wetting agents, solvents, co-solvents, co-surfactants, densifiers, bridging materials, and mixtures thereof.

In an optional non-limiting embodiment of the method and/or the oil-based drilling fluid, the selected modified surfactant may be present in a concentration from about 0.1% w/w independently to about 20% w/w of the total oil-based drilling fluid. The modified surfactant may optionally have at least one spacer arm, i.e. an extension between the hydrophilic group and at least one lipophilic group, having from about 1 propoxy moieties independently to about 20 propoxy moieties, from about 0 ethoxy moieties independently to about 20 ethoxy moieties, and combinations thereof.

The modified surfactant, at a minimum, has a hydrophilic group and at least one lipophilic moiety attached to the hydrophilic group. The viscosity of the modified surfactant can be controlled by whether it has a spacer arm between the hydrophilic head and a lipophilic chain and/or whether the there are several lipophilic chains attached to the hydrophilic head. The modified surfactant may then have better interaction with a conventional oil and/or with a polar oil.

### BRIEF DESCRIPTION OF THE DRAWINGS

FIG. 1 is an example of an extended surfactant molecule that may resemble a typical branch of a dendritic extended surfactant molecule;

FIG. 2 is an illustration of a dendritic surfactant molecule with a hydrophilic center and a plurality of lipophilic tails attached to the hydrophilic center;

FIG. 3 is an illustration of a dendritic extended surfactant having a hydrophilic center, a plurality of spacer arms, and a lipophilic moiety attached to each spacer arm;

FIG. 4 is a graph illustrating the rheology measured after mixing an invert emulsion with a conventional surfactant, and the rheology of the same type of invert emulsion with a dendritic surfactant; and

FIG. 5 is a graph illustrating the rheology of each invert emulsion with each surfactant mentioned in FIG. 4 after aging for 18 hours.

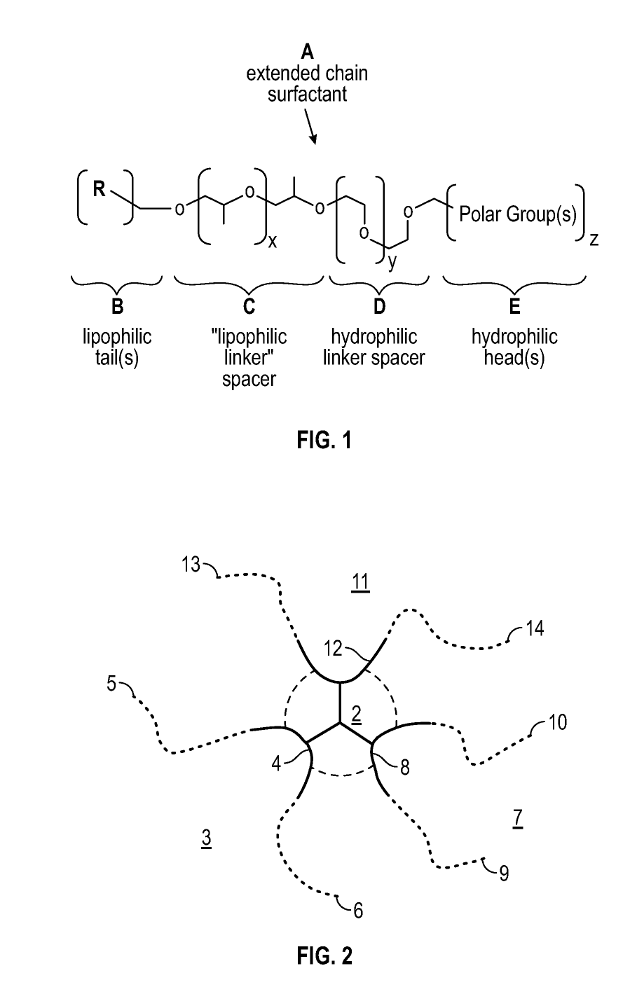

It will be appreciated that the extended surfactant molecule, the dendritic surfactant molecule and the dendritic extended surfactants illustrated in FIGS. 1-3 are not to scale or proportion and that certain features of them may be exaggerated or distorted for illustrative purposes.

### DETAILED DESCRIPTION

It has been discovered that a modified surfactant may act as an emulsifiers and/or a wetting agent when added to an oil-based drilling fluid. A modified surfactant is defined herein to include dendritic surfactants, extended surfactants, dendritic extended surfactants, and combinations thereof. These modified surfactants may substantially reduce the interfacial tension and thereby improve interfacial interaction between the non-polar continuous phase and the polar non-continuous phase within the oil-based drilling fluid. By improving the interfacial properties, the oil-based drilling fluid may have enhanced water droplet size stabilization and increased lubricity, which increases the rate of penetration (ROP). Moreover, the modified surfactant may be used in less quantities compared to typical surfactants used within the oil-based drilling fluid.

The modified surfactants may also be capable of producing emulsions of relatively low mean droplet size (e.g. a miniemulsion or a nanoemulsion). The droplets may act as carriers for drilling fluid additives to be delivered downhole. In one non-limiting embodiment, the droplet size of the formed emulsion may range from about 0.1 microns independently to about 500 microns, or alternatively from about 0.5 microns independently to about 100 microns.

The modified surfactant having a hydrophilic head and a lipophilic tail attached by the head to the hydrophilic center is incorporated into each type of modified surfactant described herein. In an alternative embodiment, the modified surfactant may have a lipophilic center and at least one hydrophilic tail that would be applicable to water-based applications, such as water-based muds in a non-limiting example.

A dendritic surfactant molecule may include at least two lipophilic chains that have been joined at a hydrophilic center and have a branch-like appearance. In each dendritic surfactant, there may be from about 2 lipophilic moieties independently to about 4 lipophilic moieties attached to each hydrophilic group, or up to about 8 lipophilic moieties attached to the hydrophilic group in one non-limiting embodiment. The dendritic surfactant may have better repulsion effect as a stabilizer at interface and/or better interaction with a polar oil. The molecular weight of the dendritic surfactant may range from about 320 g/mol to about 7572 g/mol, alternatively from about 455 g/mol to about 5455 g/mol, or from about 530 g/mol to about 3360 g/mol in another non-limiting example. These dendritic surfactant molecules are sometimes called “hyperbranched” molecules.

The modified surfactant may include a non-ionic spacer-arm extension and an ionic or nonionic polar group. An ‘extended surfactant’ as referred to herein is a modified surfactant that includes a non-ionic spacer arm between the hydrophilic group and a lipophilic tail. The non-ionic spacer-arm extension may be the result of polypropoxylation, polyethoxylation, or a combination of the two with the polypropylene oxide next to the tail and polyethylene oxide next to the head, in non-limiting embodiments. Extended surfactants are described in more detail in ‘Enhancing Solubilization in Microemulsions—State of the Art and Current Trends’, Jean-Louis Salager et al., 8 Journal of Surfactants and Detergents, 3-21 (2005), which is herein incorporated by reference in its entirety.

In one non-limiting embodiment, the spacer arm may contain from about 1 independently to about 20 propoxy moieties and/or from about 0 independently to about 20 ethoxy moieties. Alternatively, the spacer arm may contain from about 2 independently up to about 16 propoxy moieties and/or from about 2 independently up to about 8 ethoxy moieties. “Independently” as used herein with respect to ranges means any lower threshold may be combined with any upper threshold. The spacer arm extensions may also be formed from other moieties including, but not necessarily limited to, glyceryl, butoxy, glucoside, isosorbide, xylitols, and the like.

In a particular non-restrictive version, the spacer arm may contain both propoxy and ethoxy moieties. The polypropoxy portion of the spacer arm may be considered lipophilic; however, the spacer arm may also contain a hydrophilic portion to attach the hydrophilic group. The hydrophilic group may generally be a polyethoxy portion having about two or more ethoxy groups in one non-limiting embodiment. These portions are generally in blocks, rather than being mixed, e.g. randomly mixed.

In one non-limiting embodiment, the spacer arm extension may be a poly-propylene oxide chain. This type of surfactant may have a critical micelle concentration and cloud point that may vary based on the number of propylene oxide groups there are per molecule as discussed in ‘Solubilization of Polar Oils with Extended Surfactants’, Matilde Miñana-Perez et al., Colloids and Surfactants Physicochemical and Engineering Aspects, 100 (1995) 217-224, which is herein incorporated by reference in its entirety. Mixing an extended surfactant having a poly-propylene-oxide chain with a conventional ethoxylated alkyl phenol nonionic may allow for the phase behavior and formation of an emulsion to be altered by changing variables thereof, such as but not limited to, mixture composition, number of propylene oxide groups, aqueous phase salinity, etc. This is further discussed in ‘Systems Containing Mixtures of Extended Surfactants and Conventional Nonionics. Phase Behavior and Solubilization in Microemulsion’, M. Miñana-Perez et al., 4th World Surfactants Congress Proceedings, 2 (1996) 226-234, which is herein incorporated by reference in its entirety. Moreover, the polypropylene oxide chain allows for a middle phase microemulsion in alcohol-free systems with long chain synthetic and natural triglyceride oil, as well as solubilizing high molecular weight hydrocarbons, which is also discussed in Sobilization of Polar Oils in Microemulsion Systems', M. Miñana-Perez et al., Progr Colloid Polym Sci, (1995) 98: 177-179, which is herein incorporated by reference in its entirety

It should be understood that the extended surfactant is an intramolecular mixture so that the extended surfactant achieves some gradual change from hydrophilic to lipophilic across the polar/non-polar (e.g. water/oil) interface. Such surfactants may help increase and thicken the interfacial region between the polar phase and non-polar phase, which is desirable since this lowers interfacial tension and increases solubilization. A ‘dendritic extended surfactant’ as defined herein has a hydrophilic center and at least two lipophilic chains where at least one of the lipophilic chains has a spacer arm.

The lipophilic moiety of the modified surfactant may include a C₈ to C₃₀ linear or branched hydrocarbon chain, which may be saturated or unsaturated. Carbon numbers as high as 30 for the lipophilic moiety may result if the moiety is highly branched, e.g. squalane, but in most cases may be no higher than C₁₈. A suitable lipophilic moiety may be or include, but is not limited to fatty acids. The fatty acids may be or include, but are not limited to stearic acid, oleic acid, linoleic acid, palmitic acid, and combinations thereof.

Suitable hydrophilic polar heads of the modified surfactant may include, but are not necessarily limited to, polyoxyethylene (as described above), sulfate, ethoxysulfate, carboxylate, ethoxy-carboxylate, C₆ sugar, xylitol, di-xylitol, ethoxy-xylitol, carboxylate and xytol, glucose, and combinations thereof. Surfactants having a carboxylate or sulfate polar group and the synthesis thereof has been described in the journal article entitled ‘Synthesis of New Extended Surfactants Containing a Carboxylate or Sulfate Polar Group’, Alvaro Fernandez et al., 8 Journal of Surfactants and Detergents, 187-191 (2005), which is herein incorporated by reference in its entirety.

These modified surfactants may attain low interfacial tension and/or high solubilization in an oil-based drilling fluid with high molecular weight alkanes used in drilling muds, with additional properties including, but not necessarily limited to, insensitivity to temperature and to the nature of the oil being treated or absorbed. For instance, in one non-limiting embodiment the oil-based drilling fluid may function over a relatively wide temperature range of from about 20 independently to about 280° C., alternatively from about 20 independently to about 180° C. (350° F.), In another non-limiting embodiment, the modified surfactant may have an anionic group and a nonionic extension, hence they are an “intramolecular” mixture of a surfactant that becomes more hydrophilic when temperature increases and another that becomes less hydrophilic. Thus, these modified surfactants have the potential of cancelling out these effects to provide a substance that is less sensitive to temperature. Modified surfactants also avoid unwanted precipitation of the surfactant and the undesirable formation of viscous phases.

Other surfactants suitable for use with the modified surfactants in the oil-based drilling fluid may include, but are not necessarily limited to non-ionic, anionic, cationic and amphoteric surfactants and in particular, blends thereof. Suitable nonionic surfactants include, but are not necessarily limited to, alkyl polyglycosides, sorbitan esters, polyglycol esters, methyl glucoside esters, alcohol ethoxylates or alkylphenol ethoxylates (the latter of which may be better in solubilization than alcohol ethoxylates,). Suitable anionic surfactants include, but are not necessarily limited to, alkali metal alkyl sulfates, alkyl or alkylaryl sulfonates, linear or branched alkyl ether sulfates and sulfonates, alcohol polypropoxylated and/or polyethoxylated sulfates, alkyl or alkylaryl disulfonates, alkyl disulfates, alkyl sulphosuccinates, alkyl ether sulfates, linear and branched ether sulfates, and mixtures thereof. Suitable cationic surfactants include, but are not necessarily limited to, arginine methyl esters, alkanolamines and alkylenedi-amides.

When more conventional surfactants are used, an alcohol is often used as a co-surfactant to avoid or inhibit precipitation and viscous phases formation. Modified surfactants have these benefits on their own, although use of a co-surfactant may also be beneficial.

The co-surfactant may be an alcohol having from about 3 independently to about 10 carbon atoms, or in another non-limiting embodiment from about 4 independently to about 6 carbon atoms. A specific example of a suitable co-surfactant includes, but is not necessarily limited to butanol, propanol, pentanol, hexanol, heptanol, octanol (in their different isomerization structures). These co-surfactants may be alkoxylated, e.g. ethoxylated and/or propoxylated, although in most cases sufficient ethoxylation should be present to accomplish the purposes of the methods and compositions herein. In one non-restrictive embodiment the number of ethoxy units may range from about 3 independently to about 15, alternatively from about 6, independently up to about 10.

The modified surfactant structure permits the surfactant to be much longer with a bigger lipophilic group and a better solubilization, as in the embodiment when the tail is made longer, but without the precipitation penalty (because the tail is not so lipophilic as a longer alkyl group), nor fractionation into the bulk phase (because the parts that make the intramolecular mixture cannot separate and migrate into the bulk phases), and as a consequence, most of the modified surfactant stays at interface and the efficiency is high. The modified surfactant may be formulated with natural oils (edible oils and derivatives such as esters or biofuels).

The dendritic branching of the attached extended surfactants furthers these effects. With carefully designed branching of the dendritic extended surfactants, a better performance may be achieved with these oils than with ordinary light alkanes. In non limiting embodiments, carefully designing may include factors such as the length of the spacer arm, the proportion of polypropoxylation to polyethoxylation in the spacer arm, and the type of lipophilic and hydrophilic moieties in the extended surfactant molecule.

FIG. 1 presents a schematic or general illustration of an embodiment of an extended surfactant molecule A having one or more lipophilic tails B (designated R for straight, branched or cyclic alkyl or alkyl aryl groups), a lipophilic spacer arm” C (composed primarily of, if not exclusively of, propoxy moieties), a hydrophilic spacer arm D (composed primarily of, if not exclusively of, ethoxy moieties) and one or more hydrophilic heads E (polar groups). As previously discussed x may range from about 2 independently to about 20, or alternatively may range from about 0 independently to about 20. The R tail(s) contain a total of about 8 independently to about 30 carbon atoms, and the value of z may range from about 1 independently to about 3, alternatively from about 1 independently to about 2. In an alternate embodiment, butoxy moieties may be used in the lipophilic spacer arm C in place of or in addition to propoxy moieties. This structure of continuous change from lipophilic moiety to hydrophilic moiety permits the positioning of these molecules perpendicular to the oil-water interface with no significant folding on itself, hence it favors an increased thickness in the transition zone and improves solubilization and reducing tension. Specific examples of each of these portions or moieties of the molecule A are described elsewhere herein. One non-limiting, acceptable example is a carboxylate head extended surfactant having the formula (C12—PO7-EO7—COONa) and the structure:

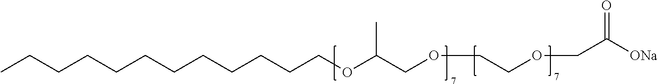

FIG. 2 is an illustration of a dendritic surfactant molecule with a hydrophilic center 2 and a plurality of lipophilic tails 5, 6, 9, 10, 13, 14 attached to the hydrophilic center 2. In an alternative embodiment, the hydrophilic center 2 may be attached to at least three surfactant chains 3, 7, 11 where each surfactant chain 3, 7, 11 may have a hydrophilic center group 4, 8, 12. A lipophilic moiety 5, 6, 9, 10, 13, 14 may be attached to each end of the hydrophilic center group 4, 8, 12.

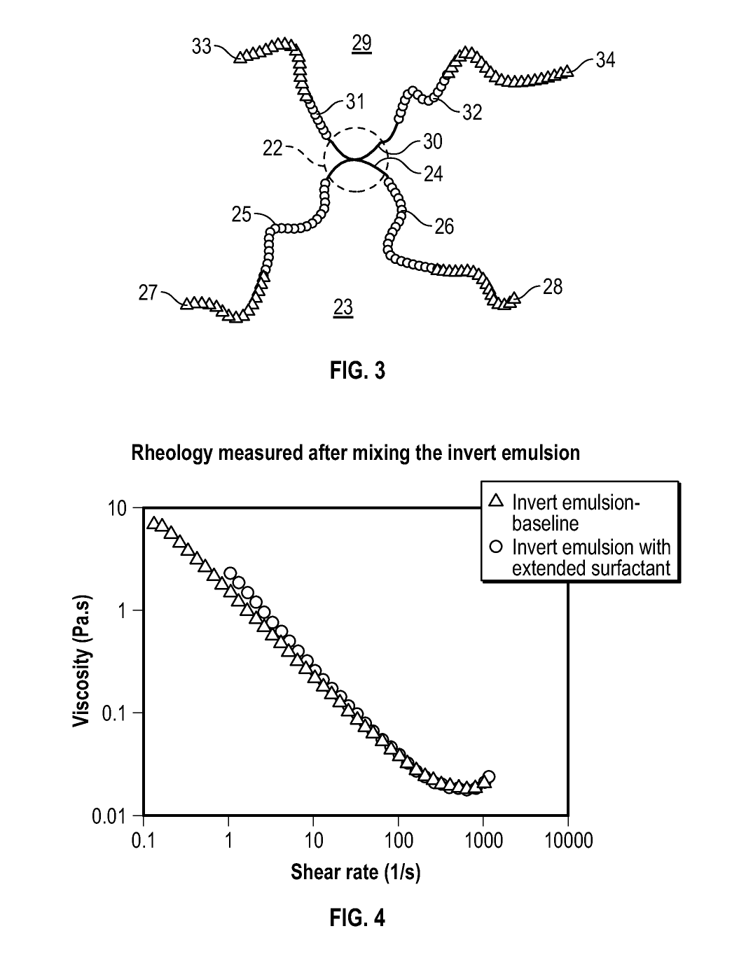

FIG. 3 is an illustration of an alternative embodiment of a dendritic extended surfactant 20 having a hydrophilic center 22, a plurality of spacer arms 25, 26, 31, 32, and a lipophilic moiety 27, 28, 33, 34 attached to each spacer arm 25, 26, 31, 32. In another non-limiting embodiment, the dendritic extended surfactant 20 may include at least two extended surfactants 23, 29 attached at a hydrophilic center 22. Each extended surfactant 23, 29 may have a hydrophilic center 24, 30. Each hydrophilic center 23, 29 may have a spacer arm 25, 26, 31, 32 where a spacer arm is attached at each end of the hydrophilic center. A lipophilic moiety 27, 28, 33, 34 may be attached to each spacer arm 25, 26, 31, 32.

In one non-limiting embodiment, the dendritic extended surfactant is present in an oil-based drilling fluid in an amount ranging from about 0.1% w/w independently to about 20% w/w (a weight % basis), or from about 0.1% w/w independently up to about 5% w/w in an alternative embodiment.

The proportion of co-surfactant to be used with the modified surfactant is difficult to specify in advance and may be influenced by a number of interrelated factors including, but not necessarily limited to, the nature of the modified surfactant, the nature of the co-surfactant, the type of drilling fluid, wellbore conditions, and the like.

Modified surfactants and co-surfactants have a different role (and structure, as noted). Co-surfactants are relatively smaller molecules, as previously described, generally alcohols having from about 4 to about 8 carbon atoms, that go into the oil-based drilling fluid (in between the surfactant molecules) to introduce some disorder (since they are smaller than the extended surfactants they cannot be arranged as regularly as molecules which have exactly the same size) and consequently such co-surfactants avoid the formation of liquid crystal gel-type phases. This geometric type of disorder is the role of the co-surfactant.

Co-surfactants are needed in most cases with ionic surfactants because the hydrophilic head groups are charged and thus interact very strongly between them and with water and thus produce a rigid structure, that is usually a liquid crystal (i.e. a more or less solid gel) at optimum formulation. Co-surfactants may be used in conjunction with some nonionic surfactants, but co-surfactants are not necessary for all nonionic surfactants. The nonionic surfactants of the polyethoxylated type (or also polyglucoside type) have a nonionic head group that has no charge, hence with weaker interactions, not strong enough to result in a solid in all cases. Moreover the ethoxylation reaction (as the propoxylation reaction) and the addition of “pieces” of starch, such as in polyglucoside head groups, is a random process and thus the length of the polyethylene oxide or polysugar head group is variable. Hence a mixture of different products may result, longer and shorter around some average, which also results in disorder, Hence, a less rigid structure results, i.e. a microemulsion instead of a gel. This is why co-surfactants are not always needed when nonionic surfactants are used. Contrariwise, co-surfactants are generally necessary with ionic surfactants, but because the head group (e.g. sulfate or carboxylate) is the same in all molecules and also because it produces stronger interactions because of the charge.

Modified surfactants also mix with conventional surfactants and they provide an extra reach on both sides of the interface. When conventional surfactants and modified surfactants are mixed, there are two degrees of freedoms to adjust both the formulation and to adjust solubilization (to the proper value for the given oil phase). Another reason to use a modified surfactant with at least one other additional surfactant, is that mixtures generally result in better performance by synergy effects. Also, the extended surfactants are mixtures themselves because the polypropoxylated spacer arm has a variable length from the random propoxylation reaction. Hence dendritic extended surfactants, even the sulfated ones which are ionic, are less likely to form gels because they are mixtures. Consequently co-surfactants (e.g. alcohols) might not always be needed with ionic dendritic extended surfactants, since the down hole temperature could be high enough to provide enough disorder.

Dendritic extended surfactants may have at least two extended surfactants. Each extended surfactant may have a spacer arm that could be larger than both head and tail, particularly if they have 10 or 15 propylene oxide groups, hence these are much larger than conventional surfactants. Each extended surfactant may be made much longer also on the lipophilic tail and hydrophilic head side. In summary, a surfactant, other than the modified surfactants described herein, are expected to be useful when used in addition to the modified surfactants.

Typically, with respect to proportions, the larger the dendritic extended surfactant size, the smaller the amount of which is necessary in the mixture with a conventional surfactant. However, the amount of dendritic extended surfactant necessary to a mixture depends on the formulation parameters of the oil-based drilling fluid, such as but not limited to type of oil and/or brine, temperatures, and the like. For instance, an “extra large” dendritic extended surfactant, for instance having from about 2 independently to about 12 lipophilic moieties, or alternatively from about 3 independently to about 6 lipophilic moieties, or from about 2 independently to about 4 lipophilic moieties in another non-limiting embodiment. In another non-limiting embodiment, an “extra large” dendritic extended surfactant may have from about 2 extended surfactants independently to about 6 extended surfactants, or from about 3 extended surfactants independently to about 8 extended surfactants. Each extended surfactant may have a branched tail with about 20 to about 30 carbon atoms, an intermediate extension or spacer with about 15 propylene oxide groups and a head with about 10 ethylene oxide groups (which will exhibit a relatively low solubility in water or oil when used alone) will be used in a small amount, such as less than about 1 to about 2% in a non-limiting example in one non-limiting example.

A method of drilling a well through a subterranean reservoir may involve drilling the well while circulating an oil-based drilling fluid through the wellbore. The oil-based drilling fluid may include, but is not limited to a water-in-oil fluid, a brine-in-oil fluid, and mixtures thereof. ‘Circulating the well’ as used herein means pumping fluid through the whole active fluid system.

In a non-limiting instance, the oil-based drilling fluid may include an emulsion, such as but not limited to a microemulsion, a macroemulsion, a miniemulsion, a nanoemulsion, and combinations thereof. Microemulsions are thermodynamically stable, macroscopically homogeneous mixtures of at least three components: an aqueous phase, a non-aqueous phase, and a surfactant. Microemulsions form spontaneously and differ markedly from the thermodynamically unstable macroemulsions, which depend upon intense mixing energy for their formation. Generally, the internal phase droplet size for nanoemulsions, which are sometimes referred to as miniemulsions, is on the order of a few nanometers. The emulsion may be broken for release of the polar non-continuous phase.

The modified surfactant may form a monolayer at the interface of the polar phase and the non-polar phase, with the lipophilic tails of the modified surfactant molecules in the non-polar phase and the hydrophilic head groups in the polar phase. The oil-based drilling fluid may include at least one additional surfactant, such as but not limited to a non-dendritic surfactant, a non-extended surfactant, a co-surfactant, and combinations thereof in an alternative embodiment.

In one non-limiting embodiment herein, the oil-based drilling fluid contains a non-polar liquid, which may include an oil or synthetic base fluid including, but not necessarily limited to, ester fluids; paraffins (such as PARA-TEQ™ fluids from Baker Hughes Drilling Fluids) and isomerized olefins (such as ISO-TEQ™ from Baker Hughes Drilling Fluids). However, diesel and mineral oils such as Escaid 110 (from Exxon) or ECD 99-DW oils (from TOTAL) can also be used as a non-polar liquid in preparing the fluid systems of herein. Other suitable non-polar liquids include, but are not necessarily limited to, limonene, pinene and other terpenes, xylene, mutual solvents, and the like.

In another non-limiting embodiment, the salts suitable for use in creating the brine include, but are not necessarily limited to sodium chloride, potassium chloride, calcium chloride, sodium bromide, calcium bromide, sodium formate, potassium formate, cesium formate, magnesium chloride or acetate and combinations thereof. The density of the brines may range from about 8.4 lb/gal independently to about 19 lb/gal (about 1 independently to about 2.276 kg/liter), although other densities may be given elsewhere herein.

The invention will be further described with respect to the following Examples which are not meant to limit the invention, but rather to further illustrate the various embodiments.

FIG. 4 illustrates the rheology measured after mixing an invert emulsion with a conventional surfactant, e.g. an oil-soluble polyamide surfactant, in an amount of 10 lb/bbl, and then mixing the same type of invert emulsion with a dendritic extended surfactant in an amount of 10 lb/bbl. The droplet size within the invert emulsion with the dendritic extended surfactant was about 4.6 microns. The droplet size within the invert emulsion with the conventional surfactant was about 3.9 microns. As represented by the graph, the invert emulsion having the dendritic extended surfactant achieved the same viscosity and shear rate as the invert emulsion with the conventional surfactant.

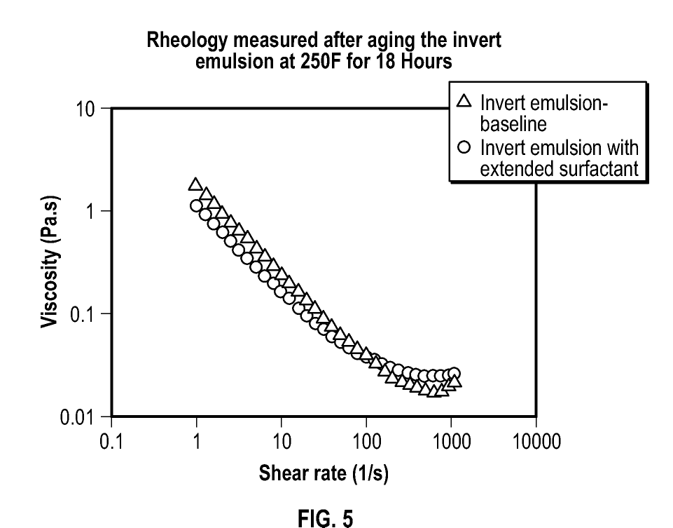

FIG. 5 illustrates the rheology of each invert emulsion with each surfactant mentioned in FIG. 4 after aging for 18 hours. The droplet size within the invert emulsion with the dendritic extended surfactant was about 3.9 microns. The droplet size within the invert emulsion with the conventional surfactant was about 1.7 microns. The viscosity and shear rate of the invert emulsions had relatively the same viscosity and shear rates. Therefore, the dendritic extended surfactant does not change the viscosity or the shear rate of the invert emulsion when compared to conventional surfactants used.

The invention will be further described with respect to the following Examples which are not meant to limit the invention, but rather to further illustrate the various embodiments.

### EXAMPLE 1

A solution of 2.84 g (0.01 mol) of oleic acid and 2.40 g (0.0100 mol) of polyethylene oxide (n=3) with 0.16 g of p-toluenesulfonic acid in 200 mL of toluene was heated under reflux for 5 hours. It was cooled and washed with 3 rounds of cold water in 5 mL increments and dried over magnesium sulfate (MgSO4). The solvent was removed under vacuum to afford a 4.09 g of (1) as yellowish oil, 81%. The reaction of Example 1 is noted below:

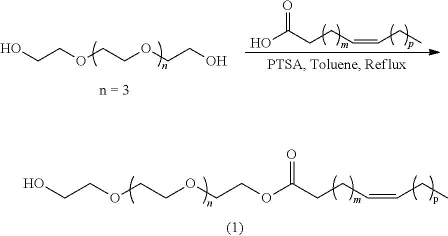

### EXAMPLE 2

600 mL of thionyl chloride was added slowly to a solution, which was 4.05 g (0.0081 mol) of compound 1 (noted in EXAMPLE 1) in 200 mL in methylene chloride. This was stirred at 60° C. for 30 minutes. 230 mL (0.0021 mol) of diethylenetriamine was added to the resulting reaction mixture and heated under reflux for 6 hours. The cold solution was neutralized with sodium carbonate and washed with 3 rounds of water in 5 mL increments and dried over calcium chloride. The solvent was removed under vacuum to afford a 3.00 g of (2) as yellowish oil, 73%. The reaction of Example 2 is noted below:

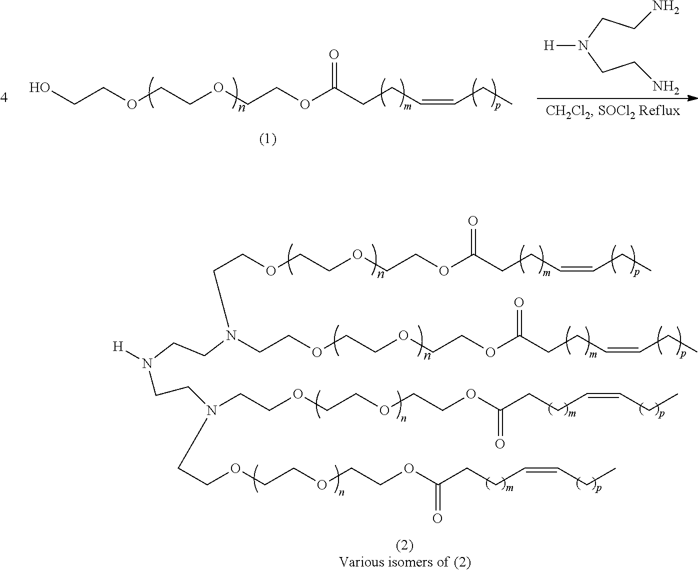

### EXAMPLE 3

0.09 g (0.00146 mol) of H3BO3 and 2.95 g (0.00145 mol) of compound 2 (noted in Example 2) was added to a solution of 200 mL of THF. The resulting reaction mixture was heated under reflux for 6 hours. The solvent was evaporated under vacuum and the residue was dissolved in 200 mL of methylene chloride and washed with 3 rounds of water in 10 mL increments. The solution was dried over MgSO4. Evaporation of solvent afforded 2.05 g of (3) as viscous brownish oil, 68%. The reaction of Example 3 is noted below:

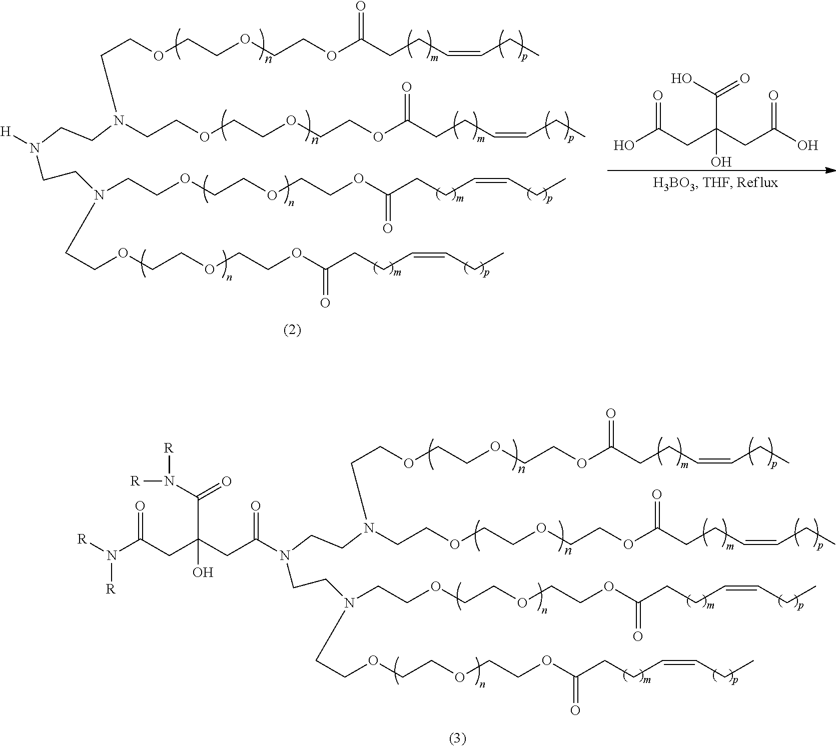

Various isomers of (3) with different degree of substitutions

### Where R═H or:

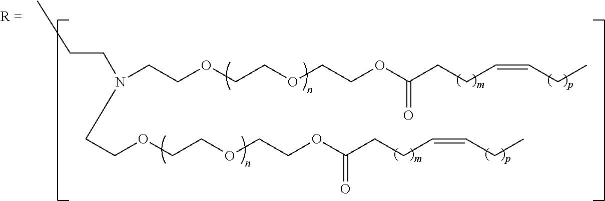

In the foregoing specification, the invention has been described with reference to specific embodiments thereof, and has been suggested as effective in providing effective methods and compositions for drilling through subterranean reservoir. However, it will be evident that various modifications and changes may be made thereto without departing from the broader spirit or scope of the invention as set forth in the appended claims. Accordingly, the specification is to be regarded in an illustrative rather than a restrictive sense. For example, specific combinations of components and other components for forming the oil-based drilling fluids, such as extended surfactants, dendritic surfactants, dendritic extended surfactants, co-surfactants, conventional surfactants, solvents, non-polar liquids, etc. and proportions thereof falling within the claimed parameters, but not specifically identified or tried in a particular oil-based drilling fluid for drilling a well through a subterranean reservoir, are anticipated to be within the scope of this invention.

The present invention may suitably comprise, consist or consist essentially of the elements disclosed and may be practiced in the absence of an element not disclosed. For instance, the method may consist of or consist essentially of a method of drilling a well through a subterranean reservoir by drilling the well while circulating an oil-based drilling fluid through the wellbore where the oil-based drilling fluid may include at least one modified surfactant, at least one non-polar continuous phase, and at least one polar non-continuous phase. The oil-based drilling fluid may additionally include at least one additive selected from the group consisting of structural stabilizers, viscosifiers, chelating agents, filtration control additives, rheological modifiers, suspending agents, dispersants, wetting agents, solvents, co-solvents, co-surfactants, densifiers, bridging materials, and mixtures thereof.

What is claimed is:

1. A method of drilling a well through a subterranean reservoir, the method comprising:
drilling the well while circulating an oil-based drilling fluid through the wellbore, wherein the oil-based drilling fluid comprises at least one modified surfactant selected from the group consisting of extended surfactants, dendritic surfactants, and dendritic extended surfactants; at least one non-polar continuous phase; and at least one polar non-continuous phase.

2. The method of claim 1, wherein the at least one modified surfactant comprises a hydrophilic center and a plurality of lipophilic moieties.

3. The method of claim 1, wherein the oil-based drilling fluid comprises an emulsion selected from the group consisting of a macroemulsion, a microemulsion, a nanoemulsion, a miniemulsion, and mixtures thereof.

4. The method of claim 3, further comprising breaking the emulsion for release of the at least one polar non-continuous phase.

5. The method of claim 1 further comprising delivering an additive downhole.

6. The method of claim 5, wherein the additive is selected from the group consisting of structural stabilizers, surfactants, viscosifiers, chelating agents, filtration control additives, rheological modifiers, suspending agents, dispersants, wetting agents, solvents, co-solvents, co-surfactants, densifiers, bridging materials, and mixtures thereof.

7. The method of claim 1, wherein the oil-based drilling fluid is selected from the group consisting of a water-in-oil emulsion, a brine-in-oil emulsion, and mixtures thereof.

8. The method of claim 1, wherein the at least one modified surfactant further comprises a propoxylated spacer arm having from about 1 to about 20 propoxy moieties and an ethoxylated spacer arm having from 0 to about 20 ethoxy moieties.

9. The method of claim 8, wherein the at least one modified surfactant comprises a lipophilic moiety selected from the group consisting of a linear or branched hydrocarbon chain, a saturated or unsaturated hydrocarbon chain, wherein the hydrocarbon chain has from about 8 to about 50 carbon atoms.

10. The method of claim 8, wherein the at least one modified surfactant comprises a hydrophilic polar head selected from the group consisting of polyoxyethylene, sulfate, sulfonate, ethoxysulfate, carboxylate, ethoxy-carboxylate, C₆ sugar, xylitol, di-xylitol, ethoxy-xylitol, carboxylate and xytol, carboxylate and glucose, phosphate, and combinations thereof.

11. The method of claim 8, wherein the at least one modified surfactant comprises a lipophilic spacer arm extension and a hydrophilic polar head, wherein the at least one modified surfactant does not precipitate in the oil-based drilling fluid.

12. The method of claim 1, wherein the at least one modified surfactant is present in a concentration from about 0.1% w/w to about 20% w/w of the total oil-based drilling fluid.

13. The method of claim 1, wherein the oil-based drilling fluid further comprises at least one additional surfactant selected from the group consisting of a non-dendritic surfactant, a non-extended surfactant, a co-surfactant, and combinations thereof.

14. The method of claim 13, wherein the co-surfactant is a surface active substance selected from the group consisting of mono or poly-alcohols, low molecular weight organic acids or amines, polyethylene glycol, low ethoxylation solvents, and mixtures and combinations thereof.

15. A method of drilling a well through a subterranean reservoir, the method comprising:
drilling the well while circulating an oil-based drilling fluid through the wellbore, wherein the oil-based drilling fluid comprises at least one modified surfactant selected from the group consisting of an extended surfactant, a dendritic surfactant, and a dendritic extended surfactant; at least one non-polar continuous phase; and at least one polar non-continuous phase; and
wherein the at least one modified surfactant is present in a concentration from about 0.1% w/w to about 20% w/w of the total oil-based drilling fluid, and wherein the at least one modified surfactant comprises at least one spacer arm extension having from about 1 to about 20 propoxy moieties, from about 0 to about 20 ethoxy moieties, and combinations thereof.

16. An oil-based drilling fluid comprising at least modified surfactant selected from the group consisting of an extended surfactant, a dendritic surfactant, a dendritic extended surfactant, and combinations thereof; at least one non-polar continuous phase; at least one polar non-continuous phase; and at least one additive selected from the group consisting of structural stabilizers, viscosifiers, chelating agents, filtration control additives, rheological modifiers, suspending agents, dispersants, wetting agents, solvents, co-solvents, co-surfactants, densifiers, bridging materials, and mixtures thereof.

17. The fluid of claim 16, wherein the at least one modified surfactant comprises a hydrophilic center and a plurality of lipophilic moieties.

18. The fluid of claim 16, wherein the oil-based drilling fluid comprises an emulsion selected from the group consisting of a macroemulsion, a microemulsion, a nanoemulsion, a miniemulsion, and mixtures thereof.

19. The fluid of claim 16, wherein the oil-based drilling fluid is selected from the group consisting of a water-in-oil emulsion, a brine-in-oil emulsion, and mixtures thereof.

20. The fluid of claim 16, wherein the at least one modified surfactant further comprises a propoxylated spacer arm extension having from about 1 to about 20 propoxy moieties and an ethoxylated spacer arm having from about 0 to about 20 ethoxy moieties.

21. The fluid of claim 20, wherein the at least one modified surfactant comprises a lipophilic moiety selected from the group consisting of a linear or branched hydrocarbon chain, a saturated or unsaturated hydrocarbon chain, wherein the hydrocarbon chain has from about 8 to about 50 carbon atoms.

22. The fluid of claim 20, wherein the at least one modified surfactant comprises a hydrophilic polar head selected from the group consisting of polyoxyethylene, sulfate, sulfonate, ethoxysulfate, carboxylate, ethoxy-carboxylate, C₆ sugar, xylitol, di-xylitol, ethoxy-xylitol, carboxylate and xytol, carboxylate and glucose, phosphate, and combinations thereof.

23. The fluid of claim 20, wherein the at least one modified surfactant comprises a lipophilic spacer arm extension and a hydrophilic polar head, and wherein the at least one modified surfactant does not precipitate in the oil-based drilling fluid.

24. The fluid of claim 16, wherein the at least one modified surfactant is present in a concentration from about 0.1% w/w to about 20% w/w of the total oil-based drilling fluid.

25. The fluid of claim 16, wherein the oil-based drilling fluid further comprises at least one additional surfactant selected from the group consisting of a non-dendritic surfactant, a non-extended surfactant, a co-surfactant, and combinations thereof.

26. The fluid of claim 25, wherein the co-surfactant is a surface active substance selected from the group consisting of mono or poly-alcohols, low molecular weight organic acids or amines, polyethylene glycol, low ethoxylation solvents, and mixtures and combinations thereof.

27. An oil-based drilling fluid comprising at least one modified surfactant selected from the group consisting of an extended surfactant, a dendritic surfactant, a dendritic extended surfactant, and combinations thereof; at least one non-polar continuous phase; and at least one polar non-continuous phase; wherein the at least one modified surfactant is present in a concentration from about 0.1% w/w to about 20% w/w of the total oil-based drilling fluid, and wherein the at least one modified surfactant comprises at least one spacer arm having from about 1 to about 20 propoxy moieties, from about 0 to about 20 ethoxy moieties, and combinations thereof.
